(19) United States
(12) Patent Application Publication
(10) Pub. No.: US 2014/0000058 A1
(43) Pub. Date: Jan. 2, 2014

(54) WIPER BLADE

(71) Applicants: Kwan Hee Kim, Daegu (KR); Jae Hyuck An, Daegu (KR); Woo Sung Lee, Daegu (KR)

(72) Inventors: Kwan Hee Kim, Daegu (KR); Jae Hyuck An, Daegu (KR); Woo Sung Lee, Daegu (KR)

(21) Appl. No.: 13/691,065

(22) Filed: Nov. 30, 2012

(30) Foreign Application Priority Data
Jun. 28, 2012 (KR) 10-2012-0069929

(51) Int. Cl. B60S 1/40

(52) U.S. Cl. CPC B60S 1/40
USPC 15/250.201; 15/250.32

(57) ABSTRACT

A wiper blade. In one aspect, the wiper blade includes: a wiper strip which wipes a wiping surface; at least a pair o yoke levers which supports the wiper strip; a pair of auxiliary levers which supports the wiper strip and is coupled to a pair of the yoke levers respectively in such a manner as to perform a relative rotation with a pair of the yoke levers; and a main lever which is connected to a wiper arm and is coupled to a pair of the auxiliary levers in such a manner as to perform a relative rotation with a pair of the auxiliary levers, wherein a pair of the yoke levers, a pair of the auxiliary levers and the main lever are formed of a resin material.

### CROSS-REFERENCE TO RELATED APPLICATIONS

This application claims the benefit of Korean Patent Application No. 10-2012-0069929, filed Jun. 28, 2012, the entirety of which is hereby incorporated by reference.

### FIELD OF THE INVENTION

The present invention relates to a wiper blade and more particularly to a wiper blade for a vehicle.

### BACKGROUND OF THE INVENTION

In general, a wiper blade removes impurities, snow, rain or the like when driving and prevents a driver's front sight from being deteriorated and performs a repetitive reciprocating action in a fan shape as a motor drives a link apparatus connected to a wiper arm.

In a conventional wiper blade, a pair of metallic baking plates is coupled to a rubber-made wiper strip. The baking plate is supported by a plurality of yoke members. The yoke members are connected to each other by means of a plurality of levers.

Here, with regard to the conventional wiper blade, through use of a pin or a rivet, the yoke member and an auxiliary lever are rotatably coupled to each other, and auxiliary levers are rotatably coupled to each other. A spacer and the like which have a small friction coefficient is coupled to the coupling, portion in order to reduce frictional resistance. Therefore, the number of parts constituting one wiper blade is as many as 20 and at least 15. Since the conventional wiper blade uses a metallic main lever and a metallic sub lever, the wiper blade is heavy.

The wiper blade which has a lot of parts and large weight gives a load to the wiper arm as well as a glass surface of the vehicle when the wiper blade is installed in the vehicle. As a result, breakdown may occur and the life span of the product may be shortened. Accordingly, a light wiper blade having an excellent assemblability is required to be developed.

### SUMMARY OF THE INVENTION

One aspect of the present invention is a wiper blade. The wiper blade includes: a wiper strip which wipes a wiping surface; at least a pair of yoke levers which supports the wiper strip; a pair of auxiliary levers which supports the wiper strip and is coupled to a pair of the yoke levers respectively in such a manner as to perform a relative rotation with a pair of the yoke levers; and a main lever which is connected to a. wiper arm and is coupled to a pair of the auxiliary levers in such a manner as to perform a relative rotation with a pair of the auxiliary levers. A pair of the yoke levers, a pair of the auxiliary levers and the main lever are formed of a resin material.

The wiper blade may further include a spacer which is inserted between the auxiliary lever and the main lever and is formed of a resin material.

The inside of the main lever may include a slot which is coupled to the spacer and a catching recess which prevents the spacer from being separated. The spacer may include a rib which is coupled to the slot in a sliding manner and a catching projection which is caught by the catching recess.

The catching projection may he formed such that a degree of projection of the catching projection increases toward an end of the wiper blade from a center of the wiper blade.

The main lever may further include a catching projection which projects downward from an inner ceiling thereof The spacer may further include a catching recess which is formed in an upper portion thereof and catches the catching projection.

The main lever may further include a protruding fitting portion which protrudes downward from an inner ceiling thereof. The auxiliary lever may further include a receiving hole which is formed in an upper portion thereof and receives the protruding fitting portion.

The auxiliary lever may further include a protruding fitting portion which protrudes downward from an inner ceiling thereof. The yoke lever may further include a receiving hole which is formed in an upper portion thereof and receives the protruding fitting portion.

Another aspect of the present invention is a wiper blade. The wiper blade includes: a wiper strip which wipes a wiping surface; a pair of first yoke levers and a pair of second yoke levers which support the wiper strip; a pair of auxiliary levers which is coupled a pair of the first yoke levers and a pair of the second yoke levers respectively in such a manner as to perform a relative rotation with a pair of the first yoke levers and a pair of the second yoke levers; and a main lever which is connected to a wiper arm and is coupled to a pair of the auxiliary levers in such a manner as to perform a relative rotation with a pair of the auxiliary levers. Each of a pair of the auxiliary levers is coupled to the one first yoke lever and the one second yoke lever. A pair of the first yoke levers, a pair of the second yoke levers 26a pair of the auxiliary levers and the main lever are formed of a resin material. The auxiliary lever may include a side projection which projects from both sides of one end of the central portion of the wiper blade. The auxiliary lever may include an inner projection which projects toward the inside of a spoiler from a lower inner side of the spoiler.

### BRIEF DESCRIPTION OF THE DRAWINGS

The embodiment will be described in detail with reference to the following drawings.

FIG. 1 is a front perspective plan view of a wiper blade according to the present invention;

FIG. 2 is a perspective view of a wiper blade assembly according to the present invention;

FIG. 3a is a perspective view showing one end of a wiper strip according to the present invention;

FIG. 3b is a perspective view showing the other end of the wiper strip according to the present invention;

FIG. 4 is an exploded front view of the wiper blade according to the present invention;

FIG. 5 is an exploded perspective view of the wiper strip according to the present invention;

FIGS. 6a to 6c are perspective views showing an auxiliary lever, a yoke lever and a spacer of the wiper blade according to the present invention;

FIGS. 7a to 7c show the wiper blade supporting eight points of the wiper strip;

FIG. 8 is a cross sectional view taken along line VA of FIG. 1;

FIG. 9a is a perspective view showing how a main lever is coupled to the auxiliary lever in accordance with the present invention;

FIG. 9b is a perspective view showing the main lever and the spacer according to the present invention;

FIGS. 9c and 9d are bottom views showing the main lever and the spacer according to the present invention;

FIG. 9e is a partial perspective dissection view showing the main lever, the auxiliary lever and the wiper strip according to the present invention;

FIG. 9f is an exploded perspective view of the main lever and the auxiliary lever including a side protrusion; and

FIGS. 10a and 10b are bottom views showing the main lever and the auxiliary lever.

### DETAILED DESCRIPTION OF THE INVENTION

The following detailed description of the present invention shows a specified embodiment of the present invention and will be provided with reference to the accompanying drawings. The embodiment will be described in enough detail that. those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following, detailed description is not intended to be limited. if adequately described, the scope of the present invention is limited only by the appended claims of the present invention as well as all equivalents thereto. Similar reference numerals in the drawings designate the same or similar functions in many aspects.

Hereafter, exemplary embodiments of the present invention will be described in detail with reference to the accompanying drawings in order that the present invention may be easily implemented by those skilled in the art.

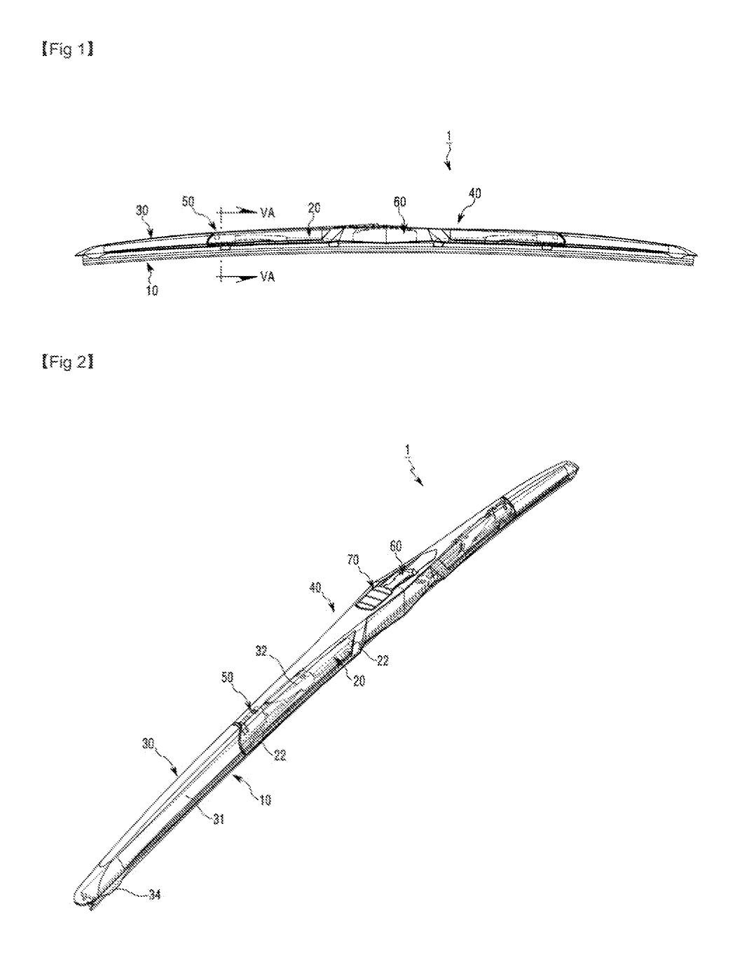

FIGS. 1 and 2 are a front perspective plan view and a perspective plan view which show an overall configuration of a wiper blade according to the present invention. Referring to FIGS. 1 and 2, the wiper blade 1 according to the present invention includes a. wiper strip 10, a pair of yoke levers 20, a pair of auxiliary levers 30, a main lever 40 and a pair at spacers 50.

Hereafter, the wiper blade shown in FIGS. 1 and 2 will be described in detail. The wiper blade 1 according to an embodiment of the present invention is connected to a front end of a wiper arm (not shown) and receives a pressurizing force from the wiper arm in a direction of a glass surface of a vehicle. The wiper arm rotates reciprocatively at a predetermined angle by a wiper motor (not shown). Accordingly the wiper blade 1 wipes the glass surface (wiping surface) of the vehicle within the predetermined angle.

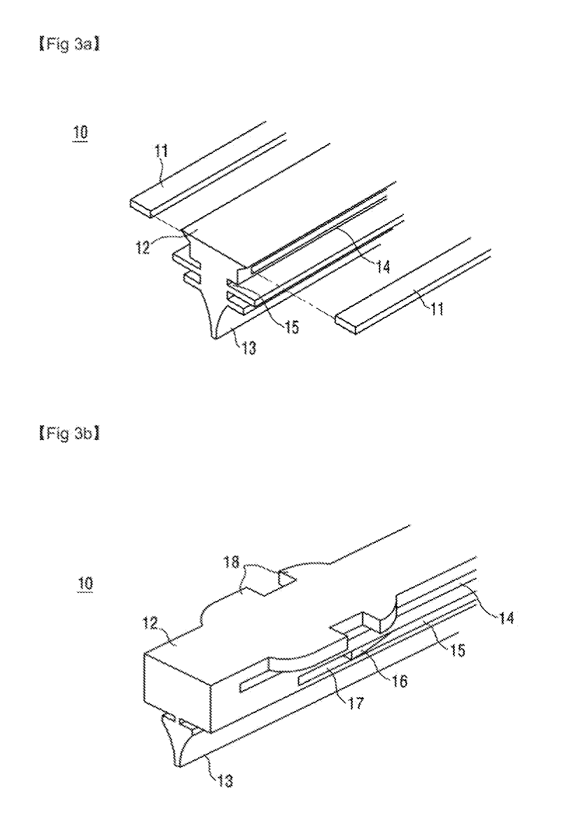

FIGS. 3a and 3b are partial perspective view showing respectively one end and the other end of the wiper strip. Referring to FIG. 1, 2, 3a and 3b, the wiper blade 1 further includes two baking plates 11 mounted on the wiper strip 10. As shown in FIGS. 1, 2, 3a and 3b, the wiper strip 10 includes a wiping lip 13 and a base 12. The wiping lip 13 contacts directly with and wipes the glass surface. The base 12 is supported by the yoke lever 20 and the auxiliary lever 30. The wiper strip 10 is disposed to contact with the glass surface of the vehicle in a sliding manner and removes impurities on the glass surface. The wiper strip 10 extends in a longitudinal direction thereof and is made of either an elastic material like rubber or an elastic composite material.

The base 12 is supported by fasteners of the yoke lever 20 and the auxiliary lever 30. The fasteners may have a yoke shape. The base 12 and the wiping lip 13 continuously extend in a longitudinal direction of the wiper strip 10. A receiving recess 14 in which the two parallel baking plates 11 may be received extends in the base 12 in a longitudinal direction thereof, The two rectangular metallic baking plates 11 having spring characteristics are received in the two baking plate receiving recesses 14 respectively. A holding portion 15 receives the fastener in a sliding manner.

As shown in FIG. 3a, the holding portion 15 at the one end of the wiper strip 10 is open so as to receive the fastener. However, as shown in FIG. 3b, the other end of the wiper strip is formed to limit the longitudinal direction movement of the fastener of one of the pair of the auxiliary levers 30. That is, the fastener supporting the other end is limited by a coupler 17 and a wall of a slope 16 provided only at the other end of the holding portion 15. Also, the longitudinal direction movement of the fastener is limited by a protrusion 18.

The baking plate 11 applies elasticity and rigidity to the wiping lip 13. When a pressurizing force is applied front the wiper arm, the pressurizing force is distributed to the wiper strip 10 through the levers. Here, the pressurizing force is distributed by the baking plate 11 in the longitudinal direction of the wiper strip 10. Accordingly, the baking plate 11 should have elasticity and rigidity to maintain a shape of the wiper strip 10. A plurality of the baking plates 11 and a plurality of the baking plate receiving recesses 14 may be provided according to the rigidity or elasticity of the wiper strip.

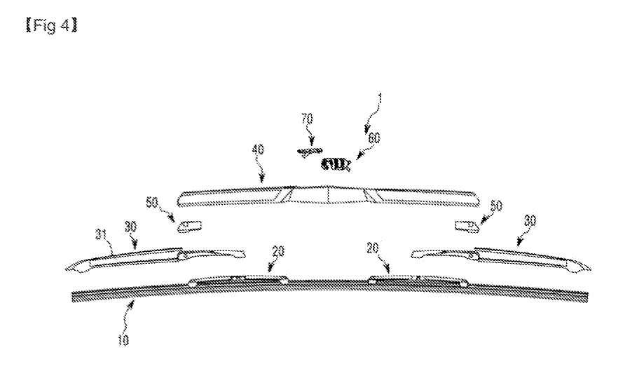

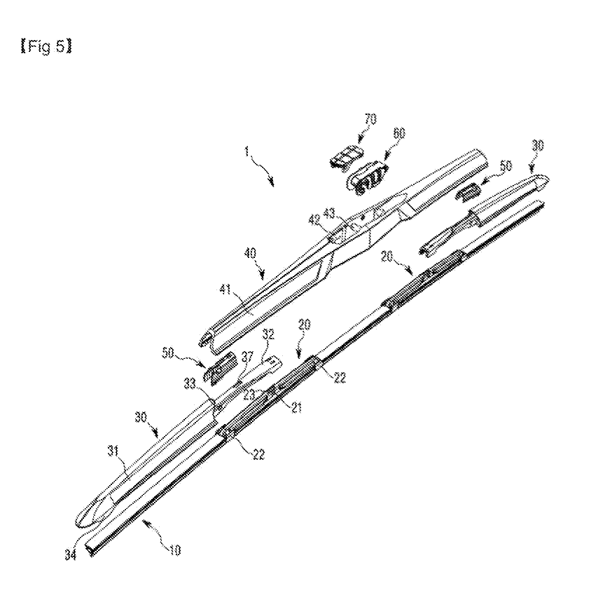

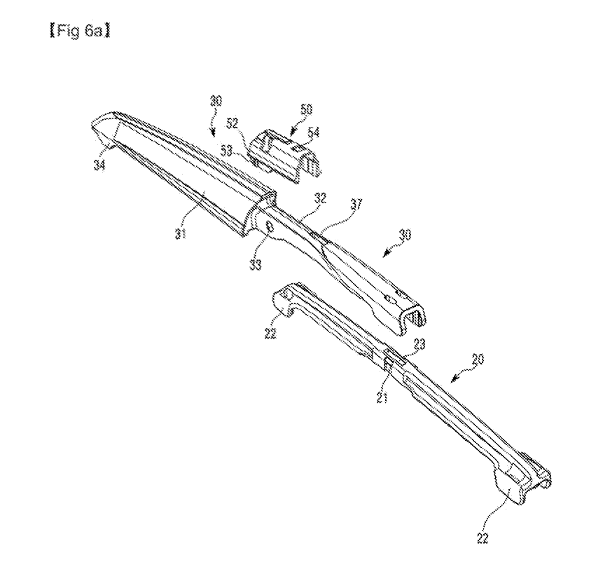

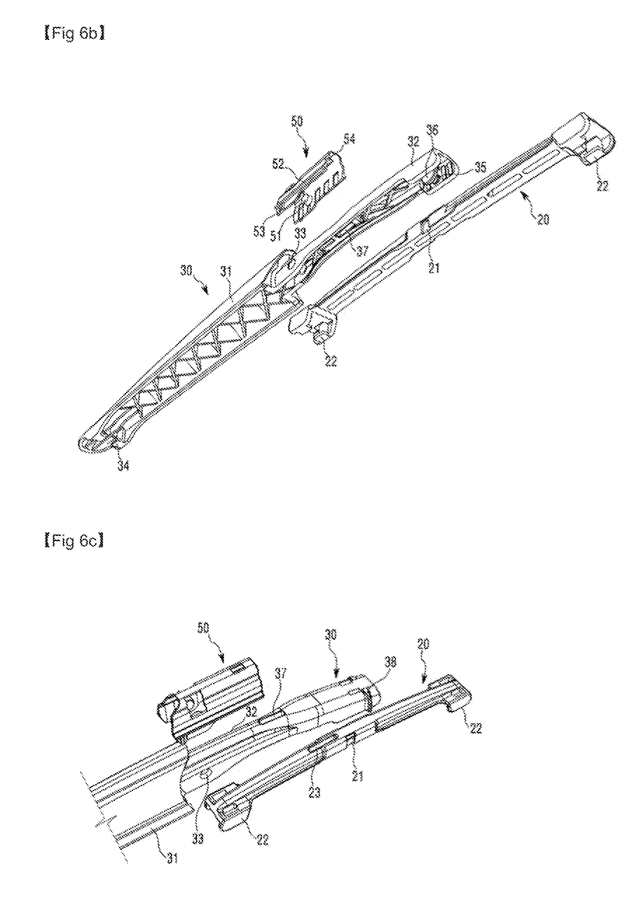

Next, an embodiment of the wiper blade according to the present invention will be described. FIGS. 4 and 5 are an exploded front view and an exploded perspective view of the wiper blade according to an embodiment of the present invention. FIGS. 6a to 6c are exploded perspective views showing the yoke lever, the auxiliary lever and the spacer.

Referring to FIGS. 4 and 5, the main lever 40 applies the pressurizing force applied from the wiper arm (not shown) to the auxiliary lever 30. The auxiliary lever 30 applies a portion of the pressurizing force to the yoke lever 20. The auxiliary lever 30 and the yoke lever 20 allow the wiper strip 10 to stably wipe the glass surface of the vehicle by pressurizing the wiper strip 10. The spacer 50 is inserted between the auxiliary lever 30 and the main lever 40, so that the rigidity of the wiper blade 10 is increased and a gap between the two levers is prevented from being created.

As shown in FIGS. 4 to 6c, the yoke lever 20 pressurizes the wiper strip 10 and supports the wiper strip 10 in such a manner as to be slidable. The yoke lever 20 includes a catching, recess 21, a pair of fasteners 22 and a receiving hole 23. The yoke lever 20 is disposed separately from an end of the wiper strip 10 toward the center of the wiper strip 10. The yoke lever 20 may be made of a resin material in an injection molding method.

The catching recess 21 of the yoke lever 20 is formed in the side of the yoke lever 20. The catching recess 21 may be formed concave in a direction of the width of the yoke lever 20. A catching protrusion 35 to be described below of the auxiliary lever 30 is coupled to the catching recess 21. The auxiliary lever 30 performs a relative rotation with the yoke lever 20 with an axis of the catching recess 21. The pair of fasteners 22 may be formed in both ends of the yoke lever 20. The fastener 22 supports the wiper strip 10 in such a manner as to be slidable.

The receiving hole 23 is formed in the upper surface of the yoke lever 20. As shown in FIGS. 4 to 6b, a protruding fitting portion 36 to be described below of the auxiliary lever 30 is inserted and fixed to the receiving hole 23. When protruding fitting portion 36 of the auxiliary lever 30 is inserted and fixed to the receiving hole 23, a gap between the auxiliary lever 30 and the yoke lever 20 is reduced and torsional flow is prevented when a wiping is performed. The resin material-made wiper blade is light and is easy to manufacture but has lower rigidity than that of a metallic wiper blade. Accordingly, in the wiper blade 10 according to the embodiment of the present invention, the protruding fitting portion 36 of the auxiliary lever 30 is inserted and fixed into the receiving hole 23 of the yoke lever 20. As a result, when the wiping is performed, a resistance to a bending moment and a torsional moment which are applied to as coupling portion of the two levers is increased. There is also an effect that a gap between the two levers is reduced. In the embodiment of the present invention, a cross section as viewed from the top of the receiving hole 23 has a quadrangular shape. However, the shape of the cross section of the receiving hole 23 is not limited to this.

Also, as shown in FIG. 6c, the receiving hole 23 may be formed separately from the center of the yoke lever 20 in a reverse direction to the center of the wiper blade in order to increase the rigidity for the moment applied to the yoke lever 20. As will described below, the auxiliary lever 30 may be inserted into the lower portion of the main lever 40 and may include a side projection 38 for reducing a gap between the auxiliary lever 30 and a lower inner side of the main lever when the auxiliary lever 30 is pivoted.

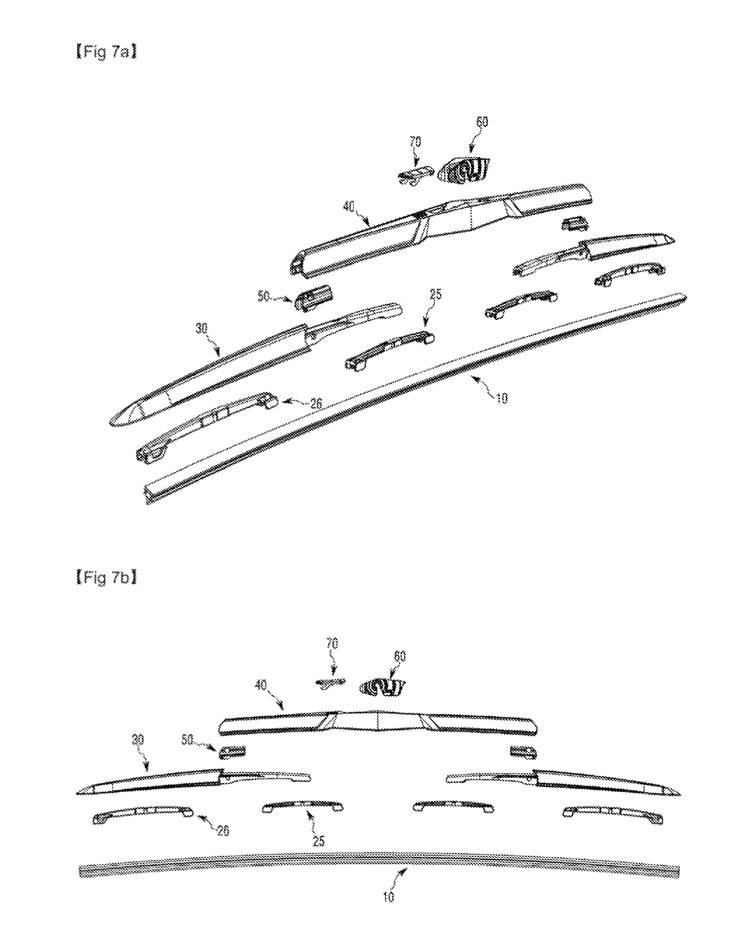

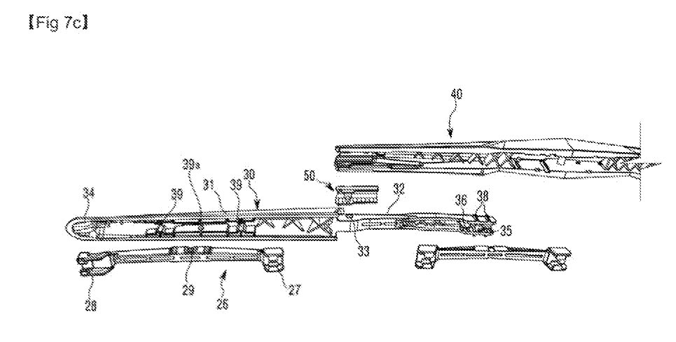

FIGS. 7a and 7b show the wiper blade supporting eight points of the wiper strip. Referring to FIGS. 7a and 7b, the wiper blade according to the embodiment of the present invention may include a pair of first yoke levers 25 and a pair of second yoke levers 26. That is, the main lever 40 applies a pressurizing force applied from the wiper arm (not shown) to the auxiliary lever 30, and the auxiliary lever 30 applies the pressurizing force to the first yoke lever 25 and the second yoke lever 26. The lower inside of a spoiler 31 of the auxiliary lever 30 is formed to have an open type for receiving the second yoke lever 26. A protrusion to be coupled to the second yoke lever 26 may he formed at the inside of the spoiler 31 of the auxiliary lever 30. The protrusion is caught by and coupled to a catching recess 29 formed in the side of the second yoke lever 26. A pair of the first yoke levers 25 and a pair of the second yoke levers 26 support four points of the wiper strip (not shown) respectively, and totally support eight points of the wiper strip. The first and the second yoke levers 25 and 26 pressurize the eight points of the wiper strip, thereby allowing the wiper strip to stably wipe the glass surface of the vehicle in other words, with the increase of the size or curvature of the glass surface of the vehicle, the two pairs of the yoke levers support and pressurize the eight points of the wiper strip. Accordingly, it is possible to more stably and evenly pressurize the wiper strip than the wiper blade having the six-point support structure.

In the meantime FIG. 7c shows another type of the auxiliary lever 30 of the wiper blade having the eight-point support structure.

Referring to FIGS. 5 to 7c, the first yoke lever 25 is the same as the above-mentioned yoke lever 20 having the six-point support structure. In the second yoke lever 26 and the first yoke lever 25, the shapes of fasteners 27 and 28 may be changed according to positions where the wiper strip 10 is supported and the length of each of the yoke levers 25 and 26.

As shown in FIG. 7e, in the auxiliary lever 30, an inner projection 39 may be formed inside the lower portion of the spoiler 31. The inner projection 39 may be formed to project toward the inside of the spoiler 31 from the lower inner side of the spoiler 31, When the wiper blade 10 is pivoted, the inner projection 39 reduces a side gap between the auxiliary lever 30 and the second yoke lever 26. A catching protrusion 39a may be formed in the central portion of the inner projection 39. The catching protrusion 39a may be coupled to the catching, recess 29 of the second yoke lever 26. Further, the auxiliary lever 30 may include the side projection 38 which reduces the gap between the auxiliary lever 30 and the lower inside of the main lever 40 and is formed at more than two positions of the auxiliary lever 30.

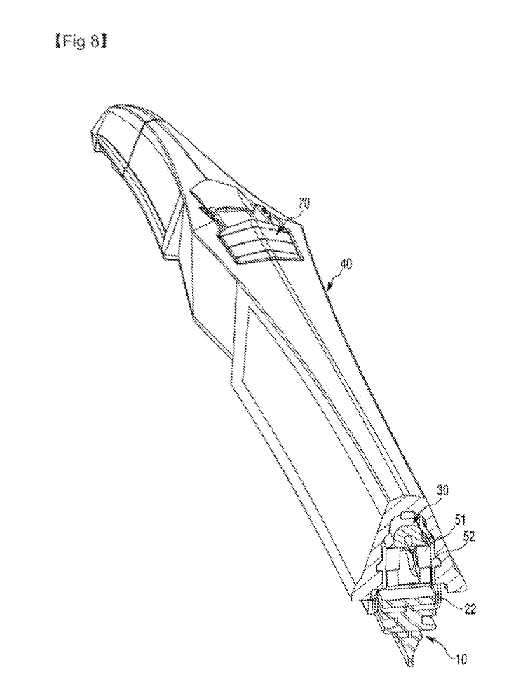

FIG. 8 is a sectional perspective view taken along line VA of the wiper blade shown in FIG. 1. Referring to FIGS. 4 to 8, the auxiliary lever 30 transfers the pressurizing force applied from the main lever 40 to the wiper strip 10 and the yoke lever 20. The auxiliary lever 30 may include the spoiler 31, an extension part 32, an insertion hole 33, a fastener 34, the catching protrusion 35, the protruding fitting portion 36 and a receiving hole 37. The fastener 34 is formed in one end of the auxiliary lever 30 and supports one end of the wiper strip 10 in such a manner as to be slidable. The catching protrusion 35 is formed in the other end of the auxiliary lever 30 and is coupled to the yoke lever 20 in such a manner as to perform a relative rotation with the yoke lever 20. The auxiliary lever 30 may be made of a resin material and may be manufactured by an injection molding method.

The spoiler 31 is integrally formed with the top surface of a portion of the auxiliary lever 30. The spoiler 31 can be implemented by processing the shape of the top surface of the auxiliary lever 30. When the wiping is performed, the spoiler 31 induces the air such that air flowing toward the glass surface of the vehicle pressurizes the auxiliary lever 30 in a direction closer to the glass surface of the vehicle. One end of the spoiler 34 includes the fastener 34. The fastener 34 supports the wiper strip 10 in such a manner as to be slidable. The fastener 34 may have a yoke shape.

The extension part 32 is coupled to the spacer 50 to be described below and is received in the lower portion of the main lever 40. The extension part 32 is coupled to the yoke lever 20 in such a manner as to perform a relative rotation with the yoke lever 20. The extension part 32 includes the insertion hole 33 functioning as a rotational axis at the time of performing a relative rotation with the main lever 40. A fitting protrusion 51 to be described below of the spacer 50 is coupled to the insertion hole 33. The catching protrusion 35 is formed in the other end of the extension part 32. The catching protrusion 35 protrudes toward the receiving hole 23 from the inner circumferential side wall of the auxiliary lever 30 in such a manner as to be elastically received in the receiving hole 23 of the yoke lever 20. Through the coupling of the catching protrusion 35 and the catching recess 24, the yoke lever 20 and the auxiliary lever 30 are separable from each other and rotatably coupled to each other. The receiving hole 37 to which a protruding fitting portion 46 to be described below of the main lever 40 is inserted and fixed is formed in the upper portion of the extension part 32. The protruding fitting portion 46 is inserted and fixed to the receiving hole 37, so that a gap between the auxiliary lever 30 and the main lever 40 is reduced and torsional flow is prevented when the wiping is performed. Accordingly, the rigidity of the resin material-made lever is increased.

The spacer 50 is inserted between the auxiliary lever 30 and the main lever 40 to be described later. The spacer 50 strengthens the coupling of the auxiliary lever 30 and the main lever 40 and reduces the gap therebetween. The fitting protrusion 51 which is inserted and fixed to the insertion hole 33 of the auxiliary lever 30 is formed in the inner surface of the spacer 50. A rib 52 is formed on the outside of the spacer 50 in the longitudinal direction of the wiper blade 1. The spacer 50 and the main lever 40 may be coupled to each other by sliding the rib 52 in a slot. 44 thrilled in the main lever 40. It is recommended that the rib 52 is formed closer to the insertion hole 33 for the purpose of increasing the rigidity of the wiper blade. Regarding a conventional metallic spacer, the rib should be placed in the lower portion of the spacer due to a manufacturing process of the conventional metallic spacer. However, since the spacer according to the embodiment of the present invention is made of a resin material, the rib can be formed closest to the insertion hole 33. A catching projection 53 received in a catching recess 45 of the main lever 40 is formed in the lower portion of the spacer 50. Also, a catching recess 54 to which a catching projection (not shown) formed in the main lever 40 is caught and connected is formed in the top surface of the spacer 50.

That is, due to the characteristic that the spacer according to the embodiment of the present invention is formed of a resin material, a shape flexibility of the spacer is increased and the spacer is able to perform all of the functions of the conventional spacer and spacer clip. Accordingly, the number of parts can be reduced. As a result, processes can be simplified and manufacturing costs can be reduced.

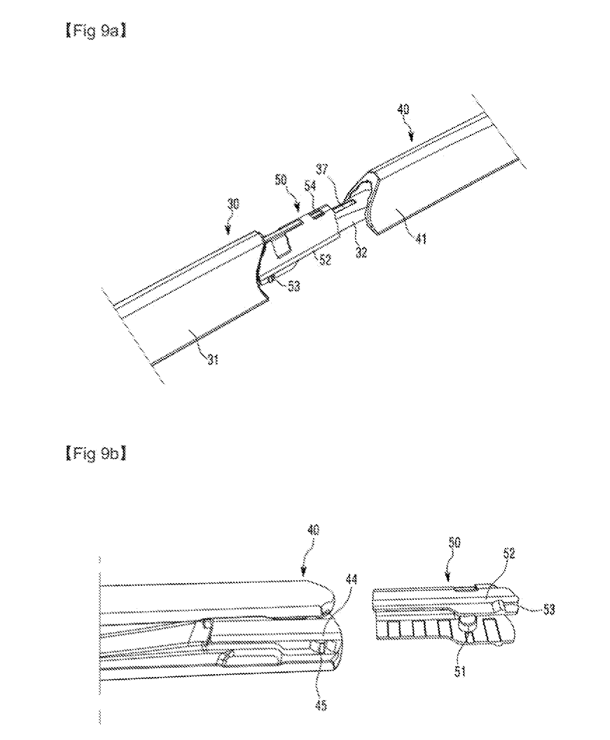

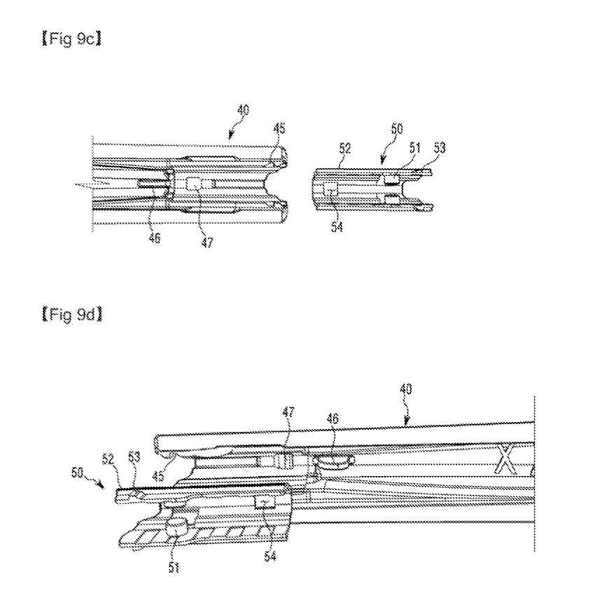

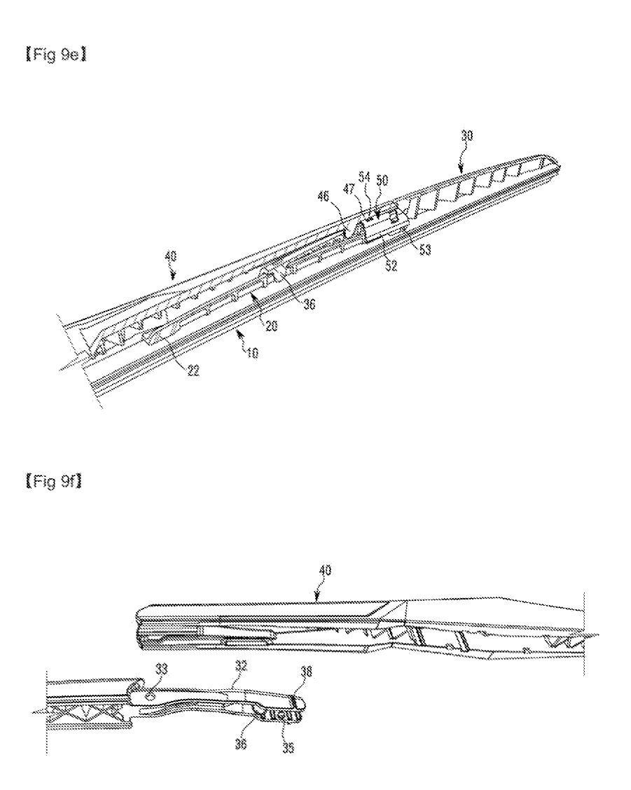

FIG. 9a is a perspective view showing a coupling, relation among the main lever, the spacer and the auxiliary lever. FIG. 9b is a perspective view showing the main lever and the spacer. FIGS. 9c and 9d are bottom views showing the main lever and the spacer. FIG. 9e is a partial perspective dissection view showing the main lever, the auxiliary lever and the wiper strip, with the exception of the spacer. FIG. 9f is a perspective view of the main lever 40 and the auxiliary lever 30 shown in FIG. 6c.

Referring to FIGS. 4 to 9e, both ends of the main lever 40 are connected a pair of the auxiliary levers 30. The main lever 40 applies the pressurizing force applied from the wiper arm (not shown) to the auxiliary lever 30. The main lever 41) may include a spoiler 41, an arm coupling hole 42, a central axis 43, the slot 44, the catching recess 45, the protruding fitting portion 46 and a catching projection 47, The main lever 41) may be made of a resin material and may be manufactured by an injection molding method.

The spoiler 41 is integrally formed with the top surface of the main lever 40. The spoiler 41 can be obtained by processing the shape of the top surface of the main lever 40. When the wiping is performed, the spoiler 31 induces the air such that air flowing toward the glass surface of the vehicle pressurizes the main lever 40 in a direction closer to the glass surface of the vehicle.

The arm coupling hole 42 is farmed in the longitudinal central portion of the main lever 40. The central axis 43 traversing the Mil coupling hole 42 in the width direction of the arm coupling hole 42 is formed in the arm coupling hole 42. An adaptor 60 which is directly connected to the wiper arm (not shown) is assembled on the central axis 43. Meanwhile, a cover member 70 may be coupled to the arm coupling hole 42.

Hereafter, a coupling relation between the main lever and the auxiliary lever will be described. Referring to FIGS. 9a and 9e, the bottom surface of the main lever 40 is open and is able to receive the extension part 32 of the auxiliary lever 30. Both ends of the main lever 40 are able to perform a relative rotation with the auxiliary lever 30 and are separably coupled to the auxiliary lever 30. Specifically, the slot 44 to which the rib 52 of the spacer 50 may be coupled in a. sliding manner is formed inside the main lever 40, Also, the catching recess 45 by which the catching projection 53 of the spacer 50 may be caught is farmed in the lower portion of the main lever 40. The catching recess 45 is formed to have a shape for receiving the catching projection 53. The catching recess 45 is symmetrically formed in both inner sides of the main lever 40. The main lever 40 is pivoted integrally with the spacer 50 about the insertion hole 33 of the auxiliary lever 30.

As shown in FIGS. 9a to 9e, the protruding fitting portion 46 which protrudes downward from the ceiling of the main lever 40 and is inserted and fixed to the receiving hole 37 of the auxiliary lever 30 is formed on the inner top surface of the both ends of the main lever 40. The protruding fitting portion 46 is inserted and fixed to the receiving hole 37, so that a gap between the auxiliary lever 30 and the main lever 40 is reduced and a resistance to a bending moment and a torsional moment is increased.

Further, the catching projection 47 which projects downward from the ceiling and is caught by the catching recess 54 of the sparer 50 is formed on the inner top surface of the both ends of the main lever 40. The catching projection 47 is caught by the catching recess 54, so that the spacer 50 and the main lever 40 can be more strongly coupled to each other.

As shown in FIGS. 9a to 9e, the auxiliary lever 30 to which the spacer 50 is coupled is coupled to the main lever 40 in a sliding manner. Here, the rib 52 of the spacer 50 is guided and slid on the slot 44 formed inside the main lever 40. The catching recess 45 is formed at the lower portion of the end of the main lever 40, and then the catching projection 53 formed in the lower portion of the spacer 50 is caught by the catching recess 45. Specifically, the catching projection 53 of the spacer 50 may have a slope in such a manner that a degree of projection of the catching projection 53 increases toward the end of the wiper blade 1 from the center of the wiper blade 1. The catching recess 45 may be formed corresponding to the catching projection 53 in such a manner as to receive the catching projection 53. Since the two levers are made of a resin material, the are slightly elastically transformed when coupled to each other. When coupled, the catching projection 53 is supported by the wall of the catching recess 45, so that the two levers are prevented from being separated. Also, when the spacer 50 slides in a direction of the main lever 40, the catching projection 47 is caught by the catching recess 54. Since the main lever 40 and the spacer 50 are all made of an elastic resin material, the spacer 50 can be coupled to the main lever 40 in an interference fit manner by giving a force to the spacer 50 in the direction of the main lever 40. When the catching projection 47 is coupled to the catching, recess 54, the spacer 50 and the main lever 40 can be prevented from being separated. In other words, the spacer 50 and the main lever 40 can be prevented from being separated in a double manner by the coupling of the catching projection 53 and the catching recess 45 and the coupling of the catching recess 54 and the catching projection 47.

Meanwhile, FIG. 9f is a bottom perspective view of the auxiliary lever 30 and the main lever 40 shown in FIG. 6c. Referring to FIG. 9f the auxiliary lever 30 may include the side projection 38 in both sides of the inner end thereof.

When the side projection 38 of the auxiliary lever 30 is inserted into the inside of the lower portion of the main lever 40, a gap between one end of the auxiliary lever 30 and both sides of the lower inside of the main lever 40 is reduced. The side projection 38 is integrally formed with the auxiliary lever 30 and is formed of an elastic resin material. The side projection 38 increases an effective area of one end of the central portion of the wiper blade of the auxiliary lever 30, increases a resistance to a moment applied to one end of the auxiliary lever 30 and reduces a side gap between the auxiliary lever 30 and the main lever 40. Therefore, the rigidity and wiping performance of the wiper blade are improved.

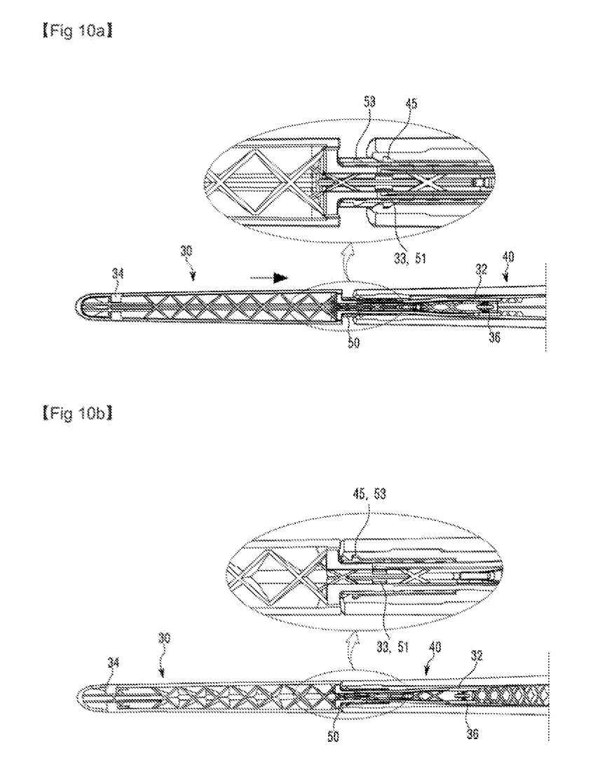

FIGS. 10aand 10b are bottom views showing a process in which the main lever, the auxiliary lever and the spacer are coupled. As shown in FIGS. 10a and 10b, the catching projection 53 of the spacer 50 is can lit by the catching recess 45 of the main lever 40. Through this, the two levers are prevented from being separated. As a result, the wiper blade 1 according to the embodiment of the present invention includes the one main lever 40, a pair of the auxiliary levers 30, and a pair of the yoke levers 20. Each lever is made of a resin material.

According to the embodiment of the present invention, the levers which may be commonly made of a metallic material are manufactured with a resin material, so that the total weight of the wiper blade 1 can be reduced. When the levers an made of a resin material instead of a metallic material, the wiper blade can be integrally molded, so that the number of parts can be reduced. Accordingly, the process becomes simpler and manufacturing cost is reduced. Also, since the levers are made of a resin material, the flexibility of the external appearance of the wiper blade 1 may be increased.

According to the embodiment of the present invention, when levers are coupled, the protruding fitting portions 36 and 46 are inserted and fixed to the receiving holes 23 and 37, so that the gap between the levers is prevented from being created and a resistance to a bending moment and a torsional moment which are applied to the lever is increased when the wiping is performed.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A wiper blade comprising:
a wiper strip which wipes at wiping surface;
at least a pair of yoke levers which supports the wiper strip;
a pair of auxiliary levers which supports the wiper strip and is coupled to a pair of the yoke levers respectively in such a manner as to perform a relative rotation with a pair of the yoke levers; and
a main lever which is connected to a wiper arm and is coupled ton pair of the auxiliary levers in such as manner as to perform a relative rotation with a pair of the auxiliary levers,
wherein a pair of the yoke levers, a pair of the auxiliary levers and the main lever are formed of a resin material.

2. The wiper blade of claim 1, further comprising a spacer which is inserted between the auxiliary lever and the main lever and is formed of a resin material.

3. The wiper blade of claim 2, Wherein the inside of the main lever comprises a slot which is coupled to the spacer and a catching recess which prevents the spacer from being separated, and wherein the spacer comprises a rib which is coupled to the slot, in a sliding manner and a catching projection which is caught by the catching recess.

4. The wiper blade of claim 3, wherein the catching projection is formed such that a degree of projection of the catching projection increases toward an end of the wiper blade from a center of the wiper blade.

5. The wiper blade of claim 3, wherein the main lever further comprises a catching projection which projects downward from an inner ceiling thereof, and wherein the spacer further comprises a catching recess which is formed in an upper portion thereof and catches the catching projection.

6. The wiper blade of claim 1, wherein the main lever comprises at protruding fitting portion which protrudes downward from an inner ceiling thereof, and wherein the auxiliary lever comprises a receiving hole which is formed in an upper portion thereof and receives the protruding fitting portion.

7. The wiper blade of claim 1, wherein the auxiliary lever comprises a protruding fitting portion which protrudes downward from an inner ceiling thereof, and wherein the yoke lever comprises a receiving hole which is formed in an upper portion thereof and receives the protruding fitting portion.

8. The wiper blade of claim 8, wherein the auxiliary lever comprises a side projection which projects from both sides of one end of the central portion of the wiper blade.

9. A wiper blade comprising:
a wiper strip which wipes a wiping surface;
a pair of first yoke levers and a pair of second yoke levers which support the wiper strip;
a pair of auxiliary levers which is coupled a pair of the first yoke levers and a pair of the second yoke levers respectively in such a manner as to perform a relative rotation with a pair of the first yoke levers and a pair of the second yoke levers; and
a main lever which is connected to a wiper arm and is coupled to a pair of the auxiliary levers in such a manner as to perform a relative rotation with a pair of the auxiliary levers,
wherein each of a pair of the auxiliary levers is coupled to the one first yoke lever and the one second yoke lever,
and wherein a pair of the first yoke levers, a pair of the second yoke levers, a pair of the auxiliary levers and the main lever are formed of a resin material.

10. The wiper blade of claim 9, wherein the auxiliary lever comprises a side projection which projects from both sides of one end of the central portion of the Wiper blade.

11. The wiper blade of claim 9, wherein the auxiliary lever comprises an inner projection which projects toward the inside of a spoiler from a lower inner side of the spoiler.
